(19) United States
(12) Patent Application Publication
(10) Pub. No.: US 2026/0156594 A1
(43) Pub. Date: Jun. 4, 2026

(54) BEAM SCANNING METHOD AND APPARATUS, AND COMPUTER-READABLE STORAGE MEDIUM

(71) Applicant: SPREADTRUM SEMICONDUCTOR (NANJING) CO., LTD., Nanjing, Jiangsu (CN)

(72) Inventors: Runquan MIAO, Pudong New Area, Shanghai (CN); Qiyishu LI, Pudong New Area, Shanghai (CN)

(21) Appl. No.: 18/717,675

(22) PCT Filed: Dec. 13, 2022
(86) PCT No.: PCT/CN2022/138578

§ 371 Date: Jun. 7, 2024

(30) Foreign Application Priority Data
Dec. 14, 2021 (CN) 202111527270.4

(51) Int. Cl. H04W 64/00

(52) U.S. Cl. CPC H04W 64/00

(57) ABSTRACT

A beam scanning method and apparatus, and a computer-readable storage medium are provided. The beam scanning method includes: acquiring position information of a target UE; and determining a first optimal beam based on the position information of the target UE.

### CROSS-REFERENCE TO RELATED APPLICATIONS

This is the U.S. national stage of application No. PCT/CN2022/138578, filed on Dec. 13, 2022. Priority under 35 U.S.C. § 119(a) and 35 U.S.C. § 365(b) is claimed from Chinese Application No. 202111527270.4, filed Dec. 14, 2021, the disclosure of which is also incorporated herein by reference.

### TECHNICAL FIELD

The present disclosure generally relates to radio communication technology field, and more particularly, to a beam scanning method and apparatus, and a computer-readable storage medium.

### BACKGROUND

With the evolution of radio communication technology, operating frequency bands are developing towards higher frequency bands such as millimeter wave, terahertz and visible light. For millimeter wave and higher frequency band communication, beams with smaller beam angles are used to make up for a relatively small coverage of high-frequency communication, thus, more beams are needed for beam scanning.

In a current beam scanning process, assuming that a base station transmits M beams and a User Equipment (UE) has N beams, it is necessary to establish M×N beam pairs.

### SUMMARY

Embodiments of the present disclosure may reduce complexity of a beam scanning process.

In an embodiment of the present disclosure, a beam scanning method is provided, including: acquiring position information of a target UE; and determining a first optimal beam based on the position information of the target UE.

In an embodiment of the present disclosure, a non-volatile or non-transitory computer-readable storage medium having computer instructions stored therein is provided, wherein when the computer instructions are executed by a processor, the above beam scanning method is performed.

In an embodiment of the present disclosure, a beam scanning apparatus including a memory and a processor is provided, wherein the memory has computer instructions stored therein, and when the processor executes the computer instructions, the above beam scanning method is performed.

### BRIEF DESCRIPTION OF THE DRAWINGS

FIG. 1 is a flow chart of a beam scanning method according to an embodiment.

FIG. 2 is an application scenario diagram of a beam scanning method according to an embodiment.

FIG. 3 is an application scenario diagram of a beam scanning method according to an embodiment.

FIG. 4 is a block diagram of a beam scanning apparatus according to an embodiment.

### DETAILED DESCRIPTION

As described in the background, in a current beam scanning process, a base station transmits M beams to cover a range of 360°. As a beam angle of beams becomes smaller, a number of beams that the base station needs to transmit increases, which significantly increases complexity of the beam scanning process.

In an embodiment of the present disclosure, as a first optimal beam is determined based on position information of a target UE, the first optimal beam can be determined without performing full-angle beam scanning, thereby effectively reducing complexity of a beam scanning process.

In order to clarify the objects, characteristics and advantages of the disclosure, embodiments of present disclosure will be described in detail in conjunction with accompanying drawings.

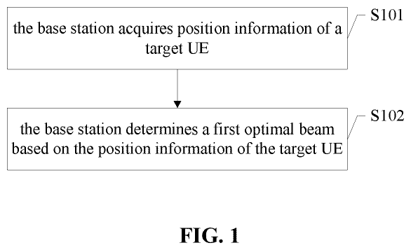

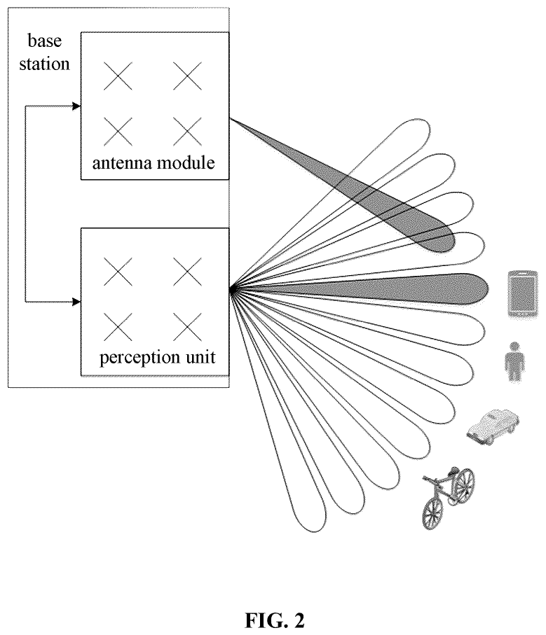

An embodiment of the present disclosure provides a beam scanning method. Referring to FIG. 1, detailed description is given below through specific steps. Referring to FIG. 2, an application scenario diagram of a beam scanning method according to an embodiment is provided.

In some embodiments, the beam scanning method including S101 and S102 may be performed by a base station. Specifically, S101 and S102 may be performed by a chip with a data processing function in a base station, or by a chip module containing a chip with a data processing function in a base station.

In S101, the base station determines position information of a target UE.

In some embodiments, the base station may acquire the position information of the target UE.

In some embodiments, the target UE may acquire its own geographical position information and use it as the first position information. After establishing a Radio Resource Control (RRC) connection with a base station, the target UE may report the first position information to the base station, so that the base station can acquire the first position information of the target UE. After acquiring the first position information reported by the target UE, the base station may directly take the first position information of the target UE as the position information of the target UE.

In some embodiments, the target UE may acquire its own geographic position information based on its built-in Global Navigation Satellite System (GNSS) module or based on a cellular network radio positioning method. If the target UE is an on-board mobile terminal, the target UE may alternatively acquire its own geographic position information through a position area identifier (such as a Zone ID).

In some embodiments, the base station may actively acquire the first position information of the target UE. For example, after the target UE accesses the base station, the base station acquires the geographical position information of the target UE by cellular base station positioning or the like.

In some embodiments, the first position information corresponding to the target UE may reflect a rough position corresponding to the target UE.

To acquire more accurate position information of the target UE, in some embodiments, the target UE may report its UE type information while reporting its first position information. Upon receiving the information reported by the target UE, the base station acquires the first position information of the target UE and the UE type information corresponding to the target UE.

The target UE described in the embodiments of the present disclosure may refer to a handheld mobile terminal such as a smart phone, an on-board mobile terminal such as an on-board computer, or a wearable smart electronic device. The on-board mobile terminal may include an on-board mobile terminal set on a non-motor vehicle (such as a shared bicycle) or an on-board mobile terminal set on a motor vehicle (such as a family car). Therefore, the UE type information of the target UE may include: a handheld mobile terminal, a wearable smart electronic device, an on-board mobile terminal corresponding to a family car, an on-board mobile terminal corresponding to a shared bicycle, etc.

In some embodiments, the target UE may indicate the UE type information in an explicit manner or in an implicit manner.

The explicit manner may refer to that the target UE directly indicates the UE type information in report information. For example, the target UE directly indicates the UE type as a handheld mobile terminal in indication information.

The implicit manner may refer to that the target UE indicates its corresponding UE capability and/or power level in the report information and indicates the UE type information corresponding to the target UE through different UE capabilities and/or power levels.

For example, the power level of an on-board mobile terminal is different from that of a handheld mobile terminal. The base station determines whether the target UE is an on-board mobile terminal, or a handheld mobile terminal based on the power level reported by the target UE.

One or more perception units may be provided in the base station. Through the perception unit, the base station can perceive position information of at least one perception target in all regions or partial regions of a coverage area. The perception target may be an obstacle, a vehicle or a pedestrian.

The base station may determine a perception target associated with the target UE from all perceived perception targets based on the first position information of the target UE and the UE type information of the target UE. The base station may use position information corresponding to the perception target associated with the target UE as the position information of the target UE.

In some embodiments, the perception target associated with the target UE may be the target UE, or an obstacle or another UE close to the target UE. If there are multiple perception targets close to the target UE, the number of the perception target associated with the target UE may be greater than one accordingly.

In some embodiments, there may be a large number of perception targets within the coverage area. After acquiring the perception targets within the coverage area, the base station may screen the perception targets. By screening the perception targets, computational complexity of the base station determining the perception target associated with the target UE may be reduced.

In some embodiments, the base station may be aware of in advance which places within the coverage area have fixed obstacles. When screening the perception targets, the fixed obstacles can be excluded first, thereby effectively reducing the number of perception targets.

In some embodiments, the perception unit may be a radar unit, which transmits a detection signal to perceive a perception target within the coverage area.

Referring to FIG. 2, the perception unit and an antenna module of the base station are independent modules.

In some embodiments, the perception unit may be the antenna module of the base station. In other words, the antenna module of the base station not only possesses a communication function but is also provided with a perception function.

During a perception process, the base station may control the antenna module to transmit multiple beams covering all directions. The beams transmitted by the antenna module is a detection signal. The base station may receive reflected signals corresponding to the beams and further determine a distribution of the perception targets within the coverage area.

Adopting the antenna module of the base station as the perception unit does not require additional hardware equipment, thus no extra cost is caused. In existing techniques, after controlling the antenna module to transmit multiple beams covering all directions, the base station actually only receives measurement results corresponding to one or more beams fed back by the target UE, and other beams are not fully utilized.

For example, the base station controls the antenna module to transmit 12 beams covering a range of 360°. However, the UE may only measure beams in two directions and feedback, and the remaining 10 beams are not fully utilized.

However, in the embodiments of the present disclosure, after controlling the antenna module to transmit beams covering all directions, the base station receives the reflected signals corresponding to all the beams, and further determines the distribution of the perception targets within the coverage area, thereby improving utilization efficiency of the beams.

For example, the base station controls the antenna module to transmit 12 beams covering a range of 360° in a horizontal direction. However, the UE may only measure beams in two directions and feedback. However, the base station can receive the reflected signals corresponding to the 12 beams, thus, the 12 beams are fully utilized.

It could be understood that the perception unit may be other types of unit, as long as it can acquire the perception targets within the coverage area, and a specific type of the perception unit is not limited in the embodiments of the present disclosure.

In some embodiments, the base station may first use a traditional wide beam for beam scanning. Specifically, the base station may generate multiple second beams in different directions to achieve beam scanning of 360°. After receiving the second beams sent by the base station, the target UE within the coverage of the base station may feedback Reference Signal Receiving Power (RSRP) corresponding to a corresponding number of second beams to the base station based on indication information or pre-configuration information of the base station. After receiving the RSRP fed back by the target UE, the base station may determine a second optimal beam corresponding to the target UE. For example, the base station determines that the second beam with the largest RSRP is the second optimal beam corresponding to the target UE.

A specific process and method of traditional second beam scanning may be referred to existing standards and are not described in detail in the embodiments of the present disclosure.

In the embodiments of the present disclosure, an angle range corresponding to a first beam is smaller than an angle range corresponding to the second beams. For example, the angle range corresponding to the second beams is 30°, and the angle range corresponding to the first beam is 5°.

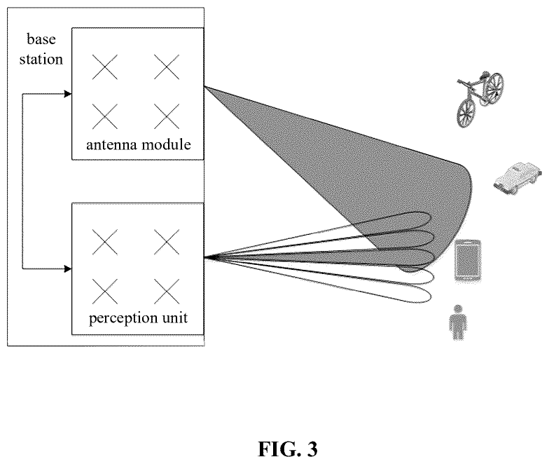

Referring to FIG. 3, an application scenario diagram of another beam scanning method according to an embodiment is provided. In FIG. 3, the base station first transmits a second beam with a relatively large angle range through the antenna module, and then transmits multiple first beams with a relatively small angle range through the perception unit.

After determining the second optimal beam, the base station may determine the position information of the target UE in a direction of the second optimal beam. Specifically, the base station may transmit a detection signal in a beam direction corresponding to the second optimal beam and determine the position information of the target UE based on an echo of the detection signal.

In S102, the base station determines a first optimal beam based on the position information of the target UE.

In some embodiments, the base station may transmit a first beam toward the target UE based on the position information of the target UE. The number of the first beam sent by the base station toward the target UE may be one or more.

In some embodiments, the base station may determine the position information of the target UE as position information corresponding to the perception target associated with the target UE based on position information corresponding to the perception targets and the first position information of the target UE. The number of the perception target associated with the target UE may be greater than one, that is, there may be other perception targets near the target UE.

For example, the target UE is a vehicle equipped with an on-board cellular communication system capable of communicating with the base station. There is a vehicle near the target UE, which is not equipped with an on-board cellular communication system, thus, the vehicle cannot communicate with the base station. The base station perceives that there are two perception targets in a direction of the target UE. One perception target is the target UE, and the other perception target is the vehicle that is not equipped with an on-board cellular communication system.

As the two perception targets are adjacent, the base station may not be able to accurately determine which perception target is the target UE. Therefore, the base station may transmit the first beam toward the two perception targets respectively, so as to determine which perception target is the target UE, and further determine the first optimal beam corresponding to the target UE.

After receiving the first beam, the target UE may feed back the received first beam to the base station. If one target UE receives one first beam, the base station determines that the target UE can use the first beam after receiving the feedback from the target UE, and accordingly the base station may determine the first beam received by the target UE as the first optimal beam.

For example, the base station transmits the first beam 1 to the perception target 1 (actually the target UE) and transmits the first beam 2 to the perception target 2 (actually a vehicle without an on-board cellular communication system). After receiving the first beam 1, the target UE1 feeds back to the base station that it has received the first beam 1, and the base station determines that the first beam 1 is the first optimal beam corresponding to the target UE1. As the perception target 2 cannot communicate with the base station, the base station may not receive feedback corresponding to the first beam 2. In some embodiments, in addition to acquiring the position information of the target UE, the base station may also acquire posture information of the target UE, and then determine the first optimal beam based on the position information of the target UE and the posture information of the target UE.

In some embodiments, the base station may transmit a detection signal within the coverage area and determine the posture information of the target UE based on an echo of the detection signal. The posture information of the target UE may be used to characterize a posture of the target UE. For example, if the target UE is a handheld mobile terminal, the posture information of the target UE may be the target UE being placed flat on a table with its back cover facing upward.

After acquiring the posture information of the target UE, the base station may determine the perception target associated with the target UE from multiple perception targets based on the posture information of the target UE and the first position information of the target UE, and further determine the position information of the target UE and the first optimal beam.

From above, in the embodiments of the present disclosure, as the first optimal beam is determined based on the position information of the target UE, the first optimal beam can be determined without performing full-angle beam scanning, thereby effectively reducing complexity of the beam scanning process.

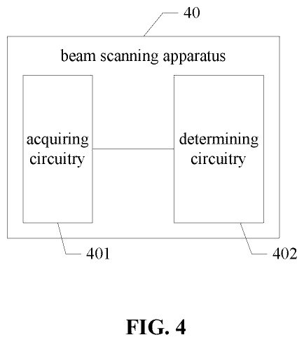

FIG. 4 is a block diagram of a beam scanning apparatus 40 according to an embodiment. The beam scanning apparatus 40 includes an acquiring circuitry 401 and a determining circuitry 402.

The acquiring circuitry 401 is configured to acquire position information of a target UE.

The determining circuitry 402 is configured to determine a first optimal beam based on the position information of the target UE.

In some embodiments, more details of the acquiring circuitry 401 and the determining circuitry 402 may be referred to the above descriptions of S101 and S102 and are not repeated here.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, wherein when the computer instructions are executed by a processor, the beam scanning method provided in any one of the above embodiments is performed.

In an embodiment of the present disclosure, a beam scanning apparatus including a memory and a processor is provided, wherein the memory has computer instructions stored therein, and when the processor executes the computer instructions, the beam scanning method provided in any one of the above embodiments is performed.

Those skilled in the art could understand that all or part of steps in the various methods in the above embodiments can be completed by instructing relevant hardware through a program, and the program can be stored in any computer-readable storage medium which includes a ROM, a RAM, a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A beam scanning method, comprising:
acquiring position information of a target User Equipment (UE); and
determining a first optimal beam based on the position information of the target UE.

2. The method according to claim 1, wherein said acquiring the position information of the target UE comprises:
receiving first position information reported by the target UE; and
taking the first position information as the position information of the target UE.

3. The method according to claim 1, wherein said acquiring the position information of the target UE comprises:
receiving first position information and UE type information reported by the target UE;
acquiring position information corresponding to all perception targets within a coverage area;
determining, based on the first position information and the UE type information, a perception target associated with the target UE from all the perception targets; and
taking position information corresponding to the perception target associated with the target UE as the position information of the target UE.

4. The method according to claim 3, wherein said acquiring the position information corresponding to all perception targets within the coverage area comprises:
transmitting a detection signal within the coverage area and determining the position information corresponding to all the perception targets within the coverage area based on an echo of the detection signal.

5. The method according to claim 1, wherein said acquiring the position information of the target UE comprises:
generating second beams and performing beam scanning;
determining a second optimal beam based on feedback from the target UE; and
determining the position information of the target UE based on the second optimal beam, wherein a beam angle corresponding to a first beam is smaller than a beam angle corresponding to the second beams.

6. The method according to claim 5, wherein said determining the position information of the target UE based on the second optimal beam comprises:
transmitting a detection signal in a beam direction corresponding to the second optimal beam and determining the position information of the target UE based on an echo of the detection signal.

7. The method according to claim 1, wherein said determining the first optimal beam based on the position information of the target UE comprises:
transmitting a first beam toward the target UE based on the position information of the target UE; and
taking the first beam fed back by the target UE as the first optimal beam.

8. The method according to claim 1, further comprising:
acquiring posture information of the target UE.

9. The method according to claim 8, wherein said acquiring the posture information of the target UE comprises:
transmitting a detection signal within a coverage area and acquiring the posture information of the target UE based on an echo of the detection signal.

10. The method according to claim 9, further comprising:
determining the first optimal beam based on the position information of the target UE and the posture information of the target UE.

11. (canceled)

12. A non-volatile or non-transitory computer-readable storage medium storing one or more programs, the one or more programs comprising computer instructions, which, when executed by a processor, cause the processor to:
acquire position information of a target User Equipment (UE); and
determine a first optimal beam based on the position information of the target UE.

13. A beam scanning apparatus comprising a memory and a processor, wherein the memory stores one or more programs, the one or more programs comprising computer instructions, which, when executed by the processor, cause the processor to:
acquire position information of a target User Equipment (UE); and
determine a first optimal beam based on the position information of the target UE.

14. The apparatus according to claim 13, wherein the processor is further caused to:
receive first position information reported by the target UE; and
take the first position information as the position information of the target UE.

15. The apparatus according to claim 13, wherein the processor is further caused to:
receive first position information and UE type information reported by the target UE;
acquire position information corresponding to all perception targets within a coverage area;
determine, based on the first position information and the UE type information, a perception target associated with the target UE from all the perception targets; and
take position information corresponding to the perception target associated with the target UE as the position information of the target UE.

16. The apparatus according to claim 15, wherein the processor is further caused to:
transmit a detection signal within the coverage area and determine the position information corresponding to all the perception targets within the coverage area based on an echo of the detection signal.

17. The apparatus according to claim 13, wherein the processor is further caused to:
generate second beams and perform beam scanning;
determine a second optimal beam based on feedback from the target UE; and
determine the position information of the target UE based on the second optimal beam, wherein a beam angle corresponding to a first beam is smaller than a beam angle corresponding to the second beams.

18. The apparatus according to claim 17, wherein the processor is further caused to:
transmit a detection signal in a beam direction corresponding to the second optimal beam and determine the position information of the target UE based on an echo of the detection signal.

19. The apparatus according to claim 13, wherein the processor is further caused to:
transmit a first beam toward the target UE based on the position information of the target UE; and
take the first beam fed back by the target UE as the first optimal beam.

20. The apparatus according to claim 13, wherein the processor is further caused to:
acquire posture information of the target UE.

21. The apparatus according to claim 20, wherein the processor is further caused to:
transmit a detection signal within a coverage area and acquire the posture information of the target UE based on an echo of the detection signal.
